(19) United States
(12) Patent Application Publication
(10) Pub. No.: US 2025/0010299 A1
(43) Pub. Date: Jan. 9, 2025

(54) METHODS, SYSTEMS, AND STORAGE MEDIA FOR CELL SORTING

(71) Applicant: NANJING GENSCRIPT BIOTECH CO., LTD., Nanjing (CN)

(72) Inventors: Lin WANG, Nanjing (CN); Yingyu GU, Nanjing (CN); Hong QIAN, Nanjing (CN)

(73) Assignee: NANJING GENSCRIPT BIOTECH CO., LTD., Nanjing (CN)

(21) Appl. No.: 18/353,060

(22) Filed: Jul. 14, 2023

(30) Foreign Application Priority Data
Jul. 3, 2023 (CN) 202310808209.X

(51) Int. Cl. B01L 3/00

(52) U.S. Cl. CPC B01L 3/502761; B01L 2200/0652; B01L 2300/0681; B01L 2400/043

(57) ABSTRACT

Some embodiments of the present disclosure provide a method, a system, and a storage medium for cell sorting. The method includes: determining a count of iterations of a rough sorting operation based on a count of labeled cells in an initial cell suspension in a sample bag; obtaining an intermediate cell suspension by performing the count of iterations of rough sorting operation on the initial cell suspension, which is divided into portions according to the count of iterations; and performing at least one fine sorting operation on the intermediate cell suspension.

### CROSS-REFERENCE TO RELATED APPLICATIONS

This application claims priority of Chinese Patent Application No. 202310808209.X, filed on Jul. 3, 2023, the entire contents of which are incorporated herein by reference.

### TECHNICAL FIELD

The present disclosure relates to the field of cell sorting technology, and in particular, to a method, a system, and a storage medium for cell sorting.

### BACKGROUND

With the continuous development of cell therapy and gene therapy technologies, research on cells has gradually become a current research hotspot in the field of medicine and even in the entire life sciences. The acquisition of target cells is a key step in cell therapy, and cell sorting and purification have become critical issues in obtaining target cells with high purity. Cell sorting refers to the separation of a specific type of cells from a multicellular sample by labeling the cells with antibodies which are either fluorescently labeled or attached to immunomagnetic beads. The cells are then separated based on the properties of the fluorescence or immunomagnetic beads.

The process for cell sorting using immunomagnetic beads is simple and does not require highly skilled technical personnel. The cells obtained from this process are highly sensitive and pure, and have good cell activity and recovery rate, resulting in minimal impact on downstream applications, and thus have a wide range of potential uses. Conventional cell sorting equipment used in the process, however, often has a limited volume for sorting samples, the obtained cells based on such equipment has low purity and recovery rate.

Therefore, it is desirable to provide methods, systems, and storage media for cell sorting to achieve high-quality cell sorting results, e.g., the separated cells have a large volume, high purity, high yield, and/or reproducibility.

### SUMMARY

One or more embodiments of the present disclosure provide a method for cell sorting. The method includes: determining a count of iterations of a rough sorting operation based on a count of labeled cells in an initial cell suspension in a sample bag; obtaining an intermediate cell suspension by performing the count of iterations of rough sorting operation on the initial cell suspension, which is divided into portions according to the count of iterations; and performing at least one fine sorting operation on the intermediate cell suspension.

In some embodiments, performing the count of iterations of rough sorting operations on the initial cell suspension includes: causing the initial cell suspension to flow through a sorting column in the portions according to the count of iterations to perform an iteration of the rough sorting operation on each portion; and washing the sorting column in each iteration of the rough sorting operation.

In some embodiments, causing the initial cell suspension to flow through the sorting column in the portions according to the count of iterations to perform an iteration of the rough sorting operation on each portion includes: executing a first predetermined process on each portion of the initial cell suspension successively until an end condition is met, wherein the first predetermined process includes: causing each portion of the initial cell suspension in the sample bag to flow through the sorting column and enter into a solution bag; washing the sorting column to generate a first mixture, and causing the first washing mixture to flow into the solution bag; and performing elution on the sorting column to generate a first eluting mixture, and causing the first eluting mixture to flow into a non-target cell bag.

In some embodiments, in response to meeting the end condition, the method further includes executing a second predetermined process before performing the at least one fine sorting operation, wherein the second predetermined process includes: washing the sample bag to generate a second washing mixture, and causing the second washing mixture to enter the solution bag; and performing the elution on the sorting column to generate a second eluting mixture, and causing the second eluting mixture to flow into the non-target cell bag.

In some embodiments, performing the at least one fine sorting operation on the intermediate cell suspension includes: causing the intermediate cell suspension to flow through the sorting column; and washing the sorting column.

In some embodiments, the at least one fine sorting operation is performed in a third predetermined process, which includes: causing the intermediate cell suspension in a solution bag to flow through the sorting column and enter into a cell collection bag; washing the sorting column to generate a third washing mixture, and causing the third washing mixture to enter into the cell collection bag; performing the elution on the sorting column to generate a third eluting mixture, and causing the third eluting mixture to flow into a non-target cell bag; and washing the solution bag to generate a fourth washing mixture, and causing the fourth washing mixture to flow into the sorting column and enter into the cell collection bag.

In some embodiments, determining the count of iterations of rough sorting operation based on the count of labeled cells in the initial cell suspension in the sample bag includes: determining the count of labeled cells based on a sample concentration, a sample volume, and a percentage of the labeled cells input by a user; and determining the count of iterations of rough sorting operation based on the count of labeled cells.

In some embodiments, performing the at least one fine sorting operation on the intermediate cell suspension includes: after completing a current fine sorting operation, determining whether to perform a next fine sorting operation based on a cell count sequence, the cell count sequence being a ranking sequence consisting of a count of target cells or a count of non-target cells in a historical fine sorting operation and the current fine sorting operation.

One or more embodiments of the present disclosure provide a system for cell sorting. The system includes at least one storage device including a set of instructions; and at least one processor in communication with the at least one storage device, wherein when executing the set of instructions, the at least one processor is directed to cause the system to perform operations including determining a count of iterations of a rough sorting operation based on a count of labeled cells in an initial cell suspension in a sample bag; obtaining an intermediate cell suspension by performing the count of iterations of rough sorting operation on the initial cell suspension, which is divided into portions according to the count of iterations; and performing at least one fine sorting operation on the intermediate cell suspension.

One or more embodiments of the present disclosure provide a computer-readable storage medium storing computer instructions. When reading the computer instructions in the storage medium, a computer performs a method for cell sorting, comprising: determining a count of iterations of a rough sorting operation based on a count of labeled cells in an initial cell suspension in a sample bag; obtaining an intermediate cell suspension by performing the count of iterations of rough sorting operation on the initial cell suspension, which is divided into portions according to the count of iterations; and performing at least one fine sorting operation on the intermediate cell suspension.

### BRIEF DESCRIPTION OF THE DRAWINGS

The present disclosure is further described in terms of exemplary embodiments. These exemplary embodiments are described in detail with reference to the drawings.

These embodiments are non-limiting exemplary embodiments, in which like reference numerals represent similar structures throughout the several views of the drawings, and wherein:

FIG. 1 is a schematic diagram illustrating an exemplary application scenario of a system for cell sorting according to some embodiments of the present disclosure;

FIG. 2 is a block diagram illustrating an exemplary system for cell sorting according to some embodiments of the present disclosure;

FIG. 3 is a schematic diagram illustrating an exemplary cell sorting device according to some embodiments of the present disclosure;

FIG. 4 is a flowchart illustrating an exemplary process for cell sorting according to some embodiments of the present disclosure;

FIG. 5 is a schematic diagram illustrating an exemplary process for cell sorting according to some embodiments of the present disclosure; and

FIG. 6 is a schematic diagram illustrating an exemplary process for determining a sorting flow rate according to some embodiments of the present disclosure.

In the drawings, 100 represents an application scenario of the system for cell sorting, 100 represents a processor, 120 represents a storage device, 130 represents a network, 140 represents a cell sorting device, 141 represents a magnetic field assembly, 142 represents a sorting column, 143 represents a flow rate assembly, 144 represents one or more connecting pipelines, 145 represents a pressure pump, 146-1 represents a sample bag, 146-2 represents a solution bag, 146-3 represents a cell collection bag, 146-4 represents a non-target cell bag, 146-5 represents a buffer bag, a buffer waste bag 146-6, 200 represents a system for cell sorting, 210 represents a determination module, 220 represents a rough sorting operation module, 230 represents a fine sorting operation module, 610 represents a candidate sorting flow rate, 620 represents a cell count sequence, 630 represents a cell count prediction model, 640 represents a next count of non-target cells, and 650 represents a sorting flow rate.

### DETAILED DESCRIPTION

In the following detailed description, numerous specific details are set forth by way of examples in order to provide a thorough understanding of the relevant disclosure. Obviously, drawings described below are only some examples or embodiments of the present disclosure. Those skilled in the art, without further creative efforts, may apply the present disclosure to other similar scenarios according to these drawings. It should be understood that the purposes of these illustrated embodiments are only provided to those skilled in the art to practice the application, and not intended to limit the scope of the present disclosure. Unless obviously obtained from the context or the context illustrates otherwise, the same numeral in the drawings refers to the same structure or operation.

It will be understood that the terms “system,” “device,” “unit,” and/or “module” used herein are one method to distinguish different components, elements, parts, sections, or assemblies of different levels in ascending order. However, the terms may be displaced by other expressions if they may achieve the same purpose.

As used herein, the singular forms “a,” “an,” and “the” may be intended to include the plural forms as well, unless the context clearly indicates otherwise. It will be further understood that the terms “include”, “including”, “includes” and/or “comprise,” when used in the present disclosure, specify the presence of steps, operations, and/or elements, but do not exclude the presence or addition of one or more other steps, operations, and/or elements thereof.

The flowcharts used in the present disclosure illustrate operations that method/system implements according to some embodiments of the present disclosure. It is to be expressly understood, the operations of the flowcharts may be implemented not in order. Conversely, the operations may be implemented in an inverted order, or simultaneously. Moreover, one or more additional operations may be added to the flowcharts. One or more operations may be removed from the flowcharts.

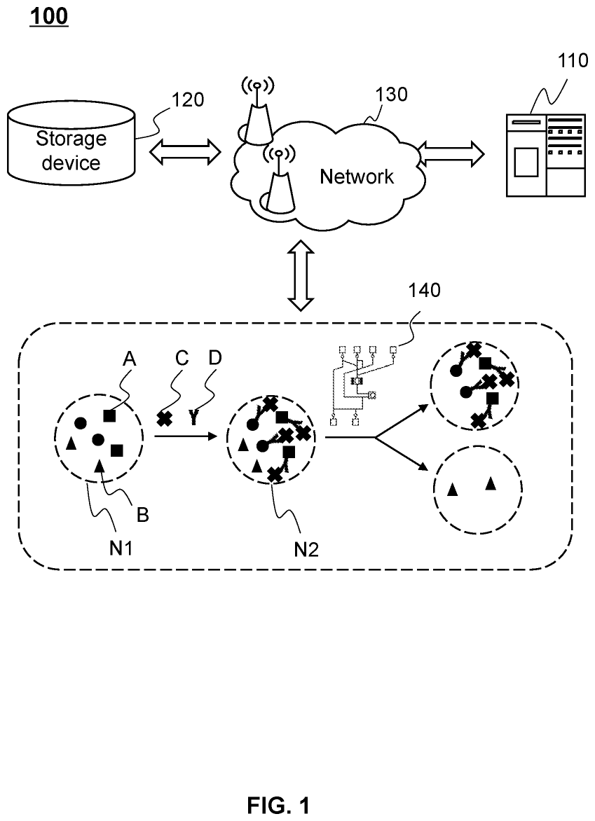

FIG. 1 is a schematic diagram illustrating an exemplary application scenario 100 of a system for cell sorting according to some embodiments of the present disclosure. As shown in FIG. 1, the application scenario 100 of the system for cell sorting may include a processor 110, a storage device 120, a network 130, and a cell sorting device 140. In some embodiments, the application scenario 100 of the system for cell sorting may also include a user terminal (not shown in the drawings).

The system for cell sorting shown in some embodiments of the present disclosure may be used to sort cells including, but not limited to, D34+ hematopoietic stem cells, yδT cells, CD3 cells, CD4 cells, CD8 cells, CD56 cells, CD14 cells, etc.

The processor 110 may be used to process data and/or information obtained from the storage device 120 and/or the cell sorting device 140. For example, the processor 110 may determine a count of iterations of a rough sorting operation based on a count of labeled cells in an initial cell suspension in a sample bag. The processor 110 may further manipulate system hardware to perform the operation(s). For example, the operation(s) may include obtaining an intermediate cell suspension by performing the count of iterations of rough sorting operation on the initial cell suspension and performing at least one fine sorting operation on the intermediate cell suspension.

In some embodiments, the processor 110 may be a single server or a group of servers. The group of servers may be centralized or distributed. In some embodiments, the processor 110 may be local or remote. In some embodiments, the processor 110 may be connected to the storage device 120 and/or the cell sorting device 140 through the network 130 or directly to access information and/or data stored thereon. In some embodiments, the processor 110 may be integrated into the cell sorting device 140. In some embodiments, the processor 110 may be implemented on a cloud platform. Merely by way of example, the cloud platform may include a private cloud, a public cloud, a hybrid cloud, a community cloud, a distributed cloud, an internal cloud, a multi-cloud, or the like, or any combination thereof. In some embodiments, the processor 110 may be integrated or mounted on the cell sorting device 140. For example, the processor 110 may be a Field Programmable Gate Array (FPGA) fixed to the cell sorting device 140.

The storage device 120 may store data, instructions, and/or any other information. In some embodiments, the storage device 120 may store data obtained from the processor 110 and/or the cell sorting device 140. In some embodiments, the storage device 120 may store data and/or instructions used by the processor 110 to perform exemplary processes described in the present disclosure.

In some embodiments, the storage device 120 may include mass storage, removable memory, volatile read-and-write memory, read-only memory (ROM), etc., or any combination thereof. In some embodiments, the storage device 120 may be implemented on the cloud platform.

In some embodiments, the storage device 120 may be connected to the network 130 to communicate with one or more components (e.g., the processor 110, the cell sorting device 140, etc.) of the system for cell sorting. The one or more components of the system for cell sorting may access data or instructions stored in the storage device 120 through the network 130. In some embodiments, the storage device 120 may be a portion of the processor 110.

The network 130 may include any suitable network that facilitates an exchange of information and/or data for the system for cell sorting. In some embodiments, the one or more components (e.g., the processor 110, the storage device 120, or the cell sorting device 140) of the system for cell sorting may be connected to and/or in communication with other components of the system for cell sorting through the network 130. For example, the processor 110 may obtain a count of labeled cells in the initial cell suspension in the sample bag from the storage device 120 or the cell sorting device 140 through the network 130 and determine the count of iterations of rough sorting operation based on the count of labeled cells.

In some embodiments, the network 130 may be one or more of a wired network or a wireless network. For example, the network 130 may include a cable network, a fiber optic network, a telecommunication network, an Internet, a local area network (LAN), a wide area network (WAN), a wireless local area network (WLAN), a metropolitan area network (MAN), a public switched telephone network (PSTN), a Bluetooth™ network, ZigBee™, near field communication (NFC), an intra-device bus, an intra-device line, cable connections, etc., or any combination thereof. The network connection among the components may be implemented in one or more of the ways mentioned above. In some embodiments, the network 130 may be any one or a combination of various topologies such as a point-to-point topology, a shared topology, a centralized topology, etc. In some embodiments, the network 130 may include one or more network access points. For example, the network 130 may include wired and/or wireless network access points, e.g., base stations and/or Internet access points, through which the one or more components of the system for cell sorting may be connected to the network 130 to exchange data and/or information.

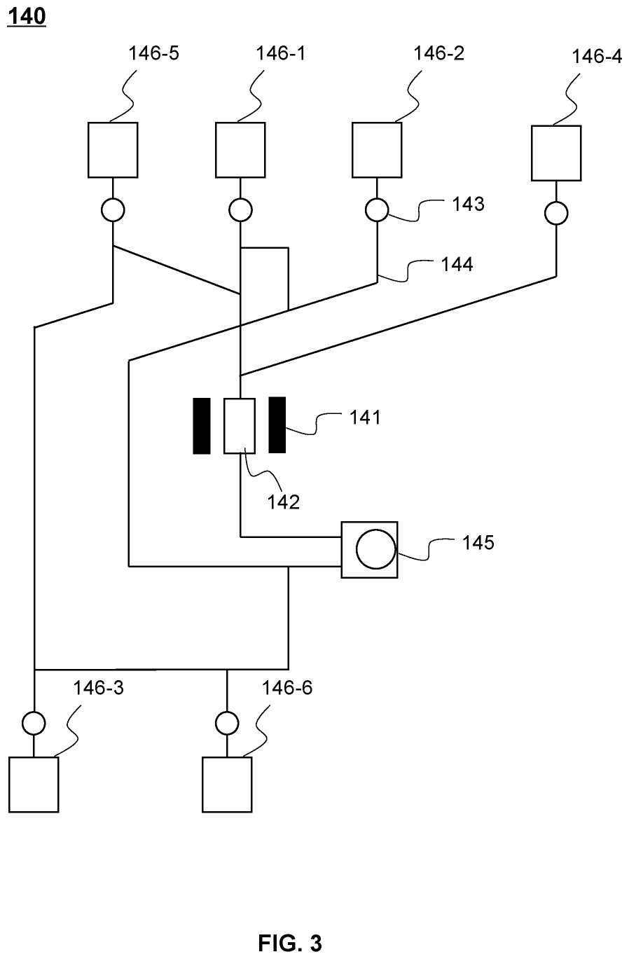

The cell sorting device 140 refers to a device for performing cell sorting operation(s) on the initial cell suspension in the sample bag to obtain target cells. More details regarding the cell sorting device 140 can be found elsewhere in the present disclosure (e.g., FIG. 3 and the description in connection with FIG. 3).

In some embodiments of the present disclosure, the cell sorting device 140 may obtain the target cells by performing immunomagnetic beads-based cell sorting on cell samples. Specifically, the cells expressing epitope are directly or indirectly bind (e.g., through specific antibodies) to the magnetic beads based on functional groups on magnetic beads and the epitope, and when the cell suspension is placed into a magnetic field, the magnetically labeled cells are retained, while unlabeled cells (without the surface antigen) can be removed, thereby achieving cell separation. In some embodiments, the magnetically labeled cells may be target cells or non-target cells. When they are the target cells, the target cells are retained in the magnetic field through adsorption, which is referred to as positive selection (or enrichment). It should be understood that the magnetic beads may activate the target cells obtained through the positive selection, affecting the application of the target cells subsequently. When the magnetically labeled cells are non-target cells, the non-target cells are retained in the magnetic field through adsorption, which is referred to as negative selection (or removal). It should be understood that for the target cells obtained by the negative selection, although magnetic beads coupled to a plurality types of antibodies are required to remove various types of non-target cells, the purity of obtained target cells is higher.

In some embodiments of the present disclosure, the processor 110 may perform the cell sorting operation(s) through the negative selection (or removal). For example, as shown in FIG. 1, a cell sample N₁ may include one or more non-target cells A and one or more target cells B. After a magnetic bead C and a specific antibody D are added into the cell sample N₁, the cell sample N₁ is incubated to obtain an initial cell suspension N₂. The magnetic bead C in the initial cell suspension N₂ is indirectly connected to the non-target cells A through the specific antibody D to obtain labeled cells. The target cells B fail to connect to the magnetic bead C or the specific antibody D because the target cells B do not have the corresponding surface antigen. Finally, the cell sorting device 140 performs the cell sorting operation(s) on the initial cell suspension N₂ to obtain one or more high-purity target cells B.

In some embodiments, the application scenario 100 of the system for cell sorting may also include one or more other devices, e.g., a user terminal.

Users may interact with the system for cell sorting through the user terminal. Exemplarily, the user terminal may include a mobile device, a tablet computer, a laptop computer, etc., or any combination thereof. For example, the user may input a sample concentration, a sample volume, and a percentage of labeled cells through the user terminal. In some embodiments, the processor 110 may be a portion of the user terminal.

It should be noted that the application scenario 100 of the system for cell sorting is provided for illustrative purposes only and is not intended to limit the scope of the present disclosure. For those skilled in the art, there are a variety of modifications or changes that may be made based on the descriptions of the present disclosure. For example, the application scenario 100 of the system for cell sorting may be implemented on other devices to achieve similar or different functions. However, changes and modifications will not depart from the scope of the present disclosure.

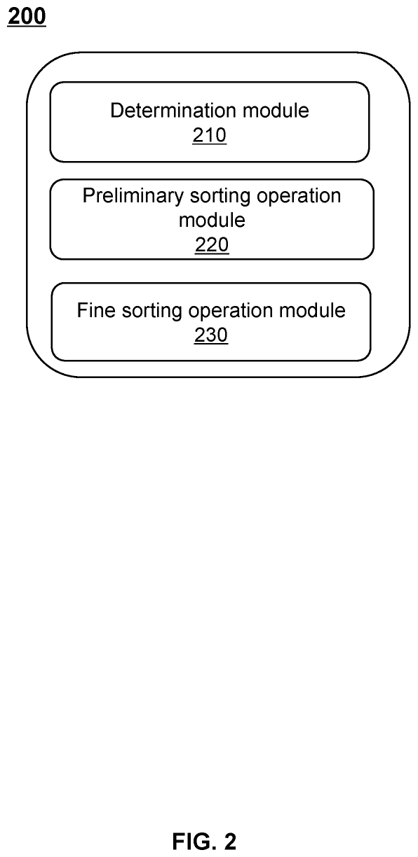

FIG. 2 is a block diagram illustrating an exemplary system 200 for cell sorting according to some embodiments of the present disclosure. In some embodiments, the system 200 for cell sorting may include a determination module 210, a rough sorting operation module 220, and a fine sorting operation module 230.

The determination module 210 may be configured to determine a count of iterations of a rough sorting operation based on a count of labeled cells in an initial cell suspension in a sample bag.

In some embodiments, the determination module 210 may be further configured to determine the count of labeled cells based on a sample concentration, a sample volume, and a percentage of the labeled cells input by a user and determine the count of iterations of rough sorting operation based on the count of labeled cells.

The rough sorting operation module 220 may be configured to obtain an intermediate cell suspension by performing the count of iterations of rough sorting operation on the initial cell suspension, which is divided into portions according to the count of iterations.

In some embodiments, the rough sorting operation module 220 may be further configured to cause the initial cell suspension to flow through a sorting column in the portions according to the count of iterations to perform an iteration of the rough sorting operation on each portion and wash the sorting column in each iteration of the rough sorting operation.

In some embodiments, the rough sorting operation module 220 may be further configured to execute a first predetermined process on each portion of the initial cell suspension successively until an end condition is met. The first predetermined process may include: causing each portion of the initial cell suspension in the sample bag to flow through the sorting column and enter into a solution bag; washing the sorting column to generate a first mixture, and causing the first washing mixture to flow into the solution bag; and performing elution on the sorting column to generate a first eluting mixture, and causing the first eluting mixture to flow into a non-target cell bag.

In some embodiments, the system 200 for cell sorting may also include an intermediate module (not shown in FIG. 2). In response to meeting the end condition, the intermediate module may be configured to execute a second predetermined process before performing the at least one fine sorting operation. The second predetermined process may include: washing the sample bag to generate a second washing mixture, and causing the second washing mixture to enter the solution bag; and performing the elution on the sorting column to generate a second eluting mixture, and causing the second eluting mixture to flow into the non-target cell bag.

The fine sorting operation module 230 may be configured to perform at least one fine sorting operation on the intermediate cell suspension to obtain target cells.

In some embodiments, performing the at least one fine sorting operation on the intermediate cell suspension may include: causing the intermediate cell suspension to flow through the sorting column; and washing the sorting column.

In some embodiments, the fine sorting operation module 230 may be further configured to cause the intermediate cell suspension in the solution bag to flow through the sorting column and enter into a cell collection bag; washing the sorting column to generate a third washing mixture, and cause the third washing mixture to enter into the cell collection bag; perform the elution on the sorting column to generate a third eluting mixture and cause the third eluting mixture to flow into a non-target cell bag; and washing the solution bag to generate a fourth washing mixture, and causing the fourth washing mixture to flow into the sorting column and enter into the cell collection bag.

In some embodiments, in a process for performing the at least one fine sorting operation, the fine sorting operation module 230 may be further configured to determine, after completing a current fine sorting operation, whether to perform a next fine sorting operation based on a cell count sequence, the cell count sequence being a ranking sequence consisting of a count of target cells or a count of non-target cells in a historical fine sorting operation and the current fine sorting operation.

More details regarding the determination module 210, the rough sorting operation module 220, and the fine sorting operation module 230 can be found elsewhere in the present disclosure (e.g., the description in connection with FIGS. 2-6).

It should be noted that the above description of the system 200 for cell sorting and its modules is for descriptive convenience only and does not limit the present disclosure to the scope of the cited embodiments. It is understood that for those skilled in the art, after understanding the principle of the system 200, various modules can be combined or there is a subsystem to connect with other modules without departing from this principle. In some embodiments, the determination module 210, the rough sorting operation module 220, and the fine sorting operation module 230 disclosed in FIG. 2 may be different modules in one system, or one module may realize two or more functions of the above modules. For example, each module may share one storage module, or each module may have its own storage module. Such deformations are within the protection scope of the present disclosure.

FIG. 3 is a schematic diagram illustrating an exemplary cell sorting device 140 according to some embodiments of the present disclosure. In some embodiments, the cell sorting device 140 may include a magnetic field assembly 141, a sorting column 142, a flow rate assembly 143, one or more bag hangers (not shown in the drawings), one or more connecting pipelines 144, a pressure pump 145, and a processor (e.g., the processor 110 which is not shown in FIG. 3).

The magnetic field assembly 141 may be used to generate a magnetic field. The sorting column 142 may be provided in the magnetic field assembly 141. The magnetic field assembly 141 may magnetize the sorting column 142 to adsorb non-target cells that are directly or indirectly connected to magnetic beads.

The sorting column 142 may be used to sort an initial cell suspension in a sample bag 146-1 or an intermediate cell suspension in a solution bag 146-2. There may be one or more sorting columns 142, and a plurality of sorting columns may be set in parallel or in series. There may be a variety of types of sorting columns. In some embodiments, the type of the sorting column 142 may be selected based on a type, a volume size, a count of cells to be sorted, etc.

The flow rate assembly 143 may be used to control a flow rate of an initial cell suspension, an intermediate cell suspension, and/or buffer in the sample bag 146-1, the solution bag 146-2, and a buffer bag 146-5, respectively, to flow through the sorting column 142 via the one or more connecting pipelines 144. In some embodiments, the flow rate assembly 143 may control the flow rate of the initial cell suspension, the intermediate cell suspension, and/or the buffer by microfluidics. The microfluidics refer to systems that use micro pipelines (with a size of tens to hundreds of microns) to handle tiny fluids (with a volume of nanoliters to liters).

One or more bag hangers may be used to hang one or more of the sample bag 146-1, the solution bag 146-2, a cell collection bag 146-3, a non-target cell bag 146-4, the buffer bag 146-5, and a buffer waste bag 146-6. The sample bag 146-1 may be used to store an initial cell suspension. The solution bag 146-2 may be used to store an intermediate cell suspension after a rough sorting operation, e.g., causing each portion of the initial cell suspension to flow through the sorting column and washing the sample bag. The cell collection bag 146-3 may be used to store a cell suspension including target cells after the fine sorting operation, e.g., causing the intermediate cell suspension to flow through the sorting column, washing the sorting column, and washing the solution bag. The non-target cell bag 146-4 may be used to store a cell suspension including non-target cells after an elution on the sorting column 142 during the rough sorting operation and/or the fine sorting operation. The buffer bag 146-5 may be used to store the buffer (e.g., phosphate buffer, etc.) used for cell sorting. The buffer waste bag 146-6 may be used to store buffer waste generated by washing the sorting column 142 in the last fine sorting operation.

The connecting pipelines 144 may be used to connect one or more components of the cell sorting device 140. For example, the sample bag 146-1, the sorting column 142, and the solution bag 146-2 may be interconnected through the connecting pipelines 144, such that the initial cell suspension in the sample bag 146-1 after being processed by the sorting column 142 can be transported to the solution bag 146-2.

The pressure pump 145 may be used to power the initial cell suspension, the intermediate cell suspension, and/or the buffer. The pressure pump 145 may include a variety of types of pressure pumps, e.g., a microfluidic pressure pump.

The processor may be used to process data related to the system for cell sorting and may control hardware to perform operations. More details regarding the processor can be found elsewhere in the present disclosure (e.g., the description in connection with FIG. 1).

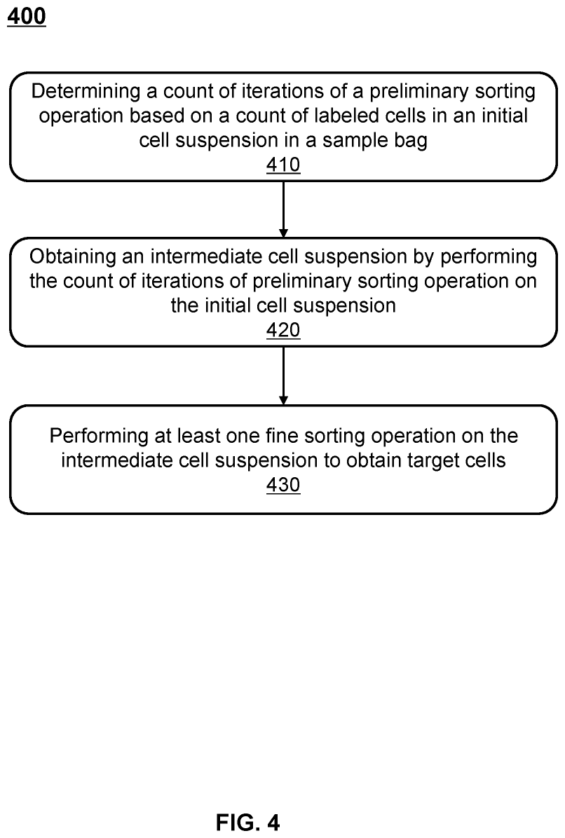

FIG. 4 is a flowchart illustrating an exemplary process for cell sorting according to some embodiments of the present disclosure. As shown in FIG. 4, a process 400 includes the following operations. In some embodiments, one or more operations of the process 400 shown in FIG. 4 may be implemented in the application scenario 100 of the system for cell sorting shown in FIG. 1. For example, the process 400 shown in FIG. 4 may be stored in a form of instructions in the storage device 120 and called and/or executed by the processor 110.

In 410, a count of iterations of a rough sorting operation may be determined based on a count of labeled cells in an initial cell suspension in a sample bag. In some embodiments, the operation 410 may be performed by the determination module 210.

The initial cell suspension may be a cell suspension from which cells need to be separated. The initial cell suspension may at least include target cells and non-target cells. The target cells are desired cells and the non-target cells are cells to be removed. The non-target cells may be indirectly connected to magnetic beads by antibodies to obtain labeled cells. In the embodiments of the present disclosure, negative selection is taken as an example for illustration. In some embodiments, the initial cell suspension may be stored in a sample bag for subsequent operations.

The labeled cells may be labeled non-target cells. That is, the labeled cells refer to non-target cells connected to magnetic beads coupled with specific antibodies. For example, the processor 110 may label the non-target cells through at least one antibody to obtain the labeled cells (also referred to as the non-target cells later).

The rough sorting operation may be an operation used for sorting the initial cell suspension first. In some embodiments, the rough sorting operation may include causing the initial cell suspension to flow through the sorting column, thereby adsorbing the labeled cells under a magnetic field. The principle of this operation is that after being labeled by the magnetic beads couped to the specific antibody, the non-target cells may be adsorbed and retained in the magnetic field; and unlabeled target cells are not retained, thereby achieving the cell sorting. In some embodiments, the magnetic field may be a preset magnetic field. In some embodiments, a flow rate of the initial cell suspension flowing through the sorting column during the rough sorting operation may be greater than a flow rate of the cell suspension flowing through the sorting column during the fine sorting operation. For example, the flow rate of the initial cell suspension flowing through the sorting column during the rough sorting operation may be 12 mL/min, 15 mL/min, 16 mL/min, 18 mL/min, etc.

In some embodiments, the processor 110 may perform other operations prior to the rough sorting operation. For example, the processor 110 may filter the initial cell suspension. As another example, the processor 110 may perform pipeline filling or perfusion to remove air from the pipelines after the cell sorting device 140 is started. As a further example, the processor 110 may wash the sorting column and a connecting pipeline of the sorting column to remove impurities that may be present in the pipeline. The above operations are exemplary, which are not limited by the present disclosure.

The initial cell suspension may include a large number of non-target cells, which may be not completely removed by performing a rough sorting operation on the initial cell suspension once. For example, an upper limit of cell adsorption of the sorting column may reach and subsequent non-target cells cannot be adsorbed. Therefore, it is necessary to determine a count of iterations of the rough sorting operation.

The count of iterations of the rough sorting operation may be a count of portions into which the intermediate cell suspension can be divided, where the portions are subjected to the rough sorting operation successively. For example, the count of iterations of the rough sorting operation may be 1, 2, 3, etc. Due to the limitation(s) (e.g., a limitation of a single maximum amount of adsorbing labeled cells) of the sorting column, a cell suspension with a large volume and a large number of labeled cells may not be entirely sorted by a single rough sorting operation. Thus, the initial cell suspension is needed to be divided into portions, thereby causing the initial cell suspension to flow through the sorting column in the portions according to the count of iterations to perform an iteration of the rough sorting operation on each portion. In some embodiments, the processor 110 may determine the count of labeled cells based on a sample concentration, a sample volume, and a percentage of the labeled cells input by a user. The sample concentration may be a concentration of the initial cell suspension. The sample volume may be a volume of the initial cell suspension. The percentage of the labeled cells may be a percentage of the labeled cells in the initial cell suspension. The count of labeled cells may be a product of the sample concentration, the sample volume and the percentage of the labeled cells.

In some embodiments, the processor 110 may determine the count of iterations of the rough sorting operation based on the count of labeled cells. In some embodiments, the count of labeled cells may be in a predetermined relationship to the count of iterations of the rough sorting operation. For example, the count of iterations of the rough sorting operation may be an integer of a value obtained by dividing the count of labeled cells by the single maximum adsorption amount of the sorting column. Merely by way of illustration, assuming that the single maximum adsorption amount of the sorting column may be 10e8 cells, and when the count of labeled cells is 10e9, the count of cell segments may be 10.

In 420, an intermediate cell suspension may be obtained by performing the count of iterations of rough sorting operation on the initial cell suspension. In some embodiments, the operation 420 may be performed by the rough sorting operation module 220.

In some embodiments, the processor 110 may perform the count of iterations of rough sorting operation on the initial cell suspension in the sample bag and place the processed intermediate cell suspension in a solution bag.

In some embodiments, the processor 110 may cause the initial cell suspension to flow through the sorting column in the portions according to the count of iterations to perform an iteration of the rough sorting operation on each portion; and wash the sorting column in each iteration of the rough sorting operation.

In some embodiments, the processor 110 may load the initial cell suspension onto the cell sorting device and performing the rough sorting operation. In some embodiments, the processor 110 may cause each portion of the initial cell suspension in the sample bag to flow through the sorting column and enter into the solution bag.

The sorting column washing refers to a process for washing unadsorbed cells in the sorting column. The sorting column washing may be completed by washing the sorting column using a washing solution. Exemplarily, the washing solution may include phosphate buffered saline (PBS), MACS® buffer, Hank's balanced salt solution (HBSS), normal saline, etc.

In some embodiments, the rough sorting operation may include: executing a first predetermined process on each portion of the initial cell suspension successively until an end condition is met. The first predetermined process includes: causing each portion of the initial cell suspension in the sample bag to flow through the sorting column and enter into a solution bag; washing the sorting column to generate a first mixture, and causing the first washing mixture to flow into the solution bag; and performing elution on the sorting column to generate a first eluting mixture, and causing the first eluting mixture to flow into a non-target cell bag.

In some embodiments, in response to meeting the end condition (i.e., a count of executed first predetermined process is equal to the count of iterations), the method for cell sorting may further include executing a second predetermined process before performing the at least one fine sorting operation. The second predetermined process includes: washing the sample bag to generate a second washing mixture, and causing the second washing mixture to enter the solution bag; and performing the elution on the sorting column to generate a second eluting mixture, and causing the second eluting mixture to flow into the non-target cell bag.

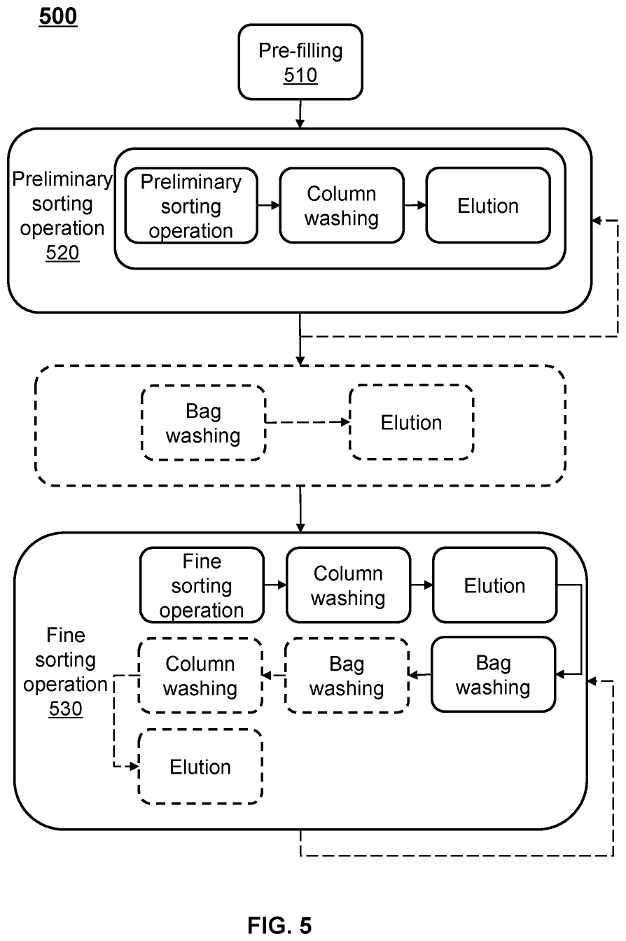

More details regarding the rough sorting operation can be found elsewhere in the present disclosure (e.g., the description in connection with FIG. 5).

In this embodiment, a certain count of non-target cells may be separated by the rough sorting operation, which increases the efficiency of the fine sorting operation and improves the purity of the target cells after the fine sorting operation. In addition, the rough sorting operation is performed on each portion of the initial cell suspension, facilitating the sorting of cells with a large volume.

In 430, at least one fine sorting operation may be performed on the intermediate cell suspension to obtain target cells. In some embodiments, the operation 430 may be performed by the fine sorting operation module 230.

The fine sorting operation may be an operation performed for further finely sorting the cells from the intermediate cell suspension in the solution bag. For example, the fine sorting operation may include causing the intermediate cell suspension to flow through the sorting column and adsorbing the labeled cells under an action of a magnetic field by the sorting column. Due to a high flow rate of the initial cell suspension flowing through the sorting column during the rough sorting operation, the intermediate cell suspension obtained from the rough sorting operation may include labeled cells that have not to be adsorbed. Therefore, the flow rate of the intermediate cell suspension may need to be reduced and a time for the intermediate cell suspension to flow through the sorting column may need to be increased, so that the sorting column may have more time to adsorb labeled cells for further sorting. In some embodiments, the principle of the fine sorting operation is the same as that of the rough sorting operation. In some embodiments, the flow rate of the intermediate cell suspension through the sorting column during the fine sorting operation (also referred to as sorting flow rate in the fine sorting operation) may be less than the flow rate of the initial cell suspension through the sorting column during the rough sorting operation (also referred to as sorting flow rate in the rough sorting operation). For example, the flow rate of the intermediate cell suspension through the sorting column during the fine sorting operation may be 4 mL/min, 5 mL/min, 6 mL/min, etc.

In some embodiments, the processor 110 may cause the intermediate cell suspension to flow through the sorting column to perform the at least one fine sorting operation; and wash the sorting column.

In some embodiments, the processor 110 may load the intermediate cell suspension after the rough sorting operation onto the cell sorting device and perform the fine sorting operation. In some embodiments, the processor 110 may cause the intermediate cell suspension in the solution bag to flow through the sorting column and enter into the cell collection bag.

The sorting column washing in the fine sorting operation is similar to that in the rough sorting operation, which is omitted herein.

In some embodiments, the at least one fine sorting operation is performed in a third predetermined process, which includes: causing the intermediate cell suspension in a solution bag to flow through the sorting column and enter into a cell collection bag; washing the sorting column to generate a third washing mixture, and causing the third washing mixture to enter into the cell collection bag; performing the elution on the sorting column to generate a third eluting mixture, and causing the third eluting mixture to flow into a non-target cell bag; and washing the solution bag to generate a fourth washing mixture, and causing the fourth washing mixture to flow into the sorting column and enter into the cell collection bag. In some embodiments, assuming that there are a plurality of fine sorting operations, the processor 110 may execute a count of the third predetermined processes corresponding to a count of the fine sorting operations. For example, the processor 110 may cause an intermediate cell suspension in the cell collection bag after a current third predetermined process to enter into the solution bag and execute a next third predetermined process. In some embodiments, the processor 110 may also determine a count of iterations of the fine sorting operation based on a count of labeled cells in the intermediate cell suspension, cause the intermediate cell suspension to flow through the sorting column in portions according to the count of iterations of the fine sorting operation to perform an iteration of the fine sorting operation on each portion, and wash the sorting column in each iteration of the fine sorting operation. In some embodiments, after the third predetermined process is executed, the processor 110 may further wash the solution bag and the sorting column, and perform the elution.

More details regarding the fine sorting operation can be found elsewhere in the present disclosure (e.g., FIG. 5 and the description thereof).

In some embodiments, the sorting flow rate in the fine sorting operation may be preset. For example, the sorting flow rate may be 5 mL/min. By reducing a common sorting flow rate in the fine sorting operation (e.g., 12 mL/min) to 5 mL/min, high-purity target cells can be obtained.

In some embodiments, when there are a plurality of fine sorting operations, a flow rate of the intermediate cell suspension flowing through the sorting column may be determined based on a cell count sequence. The cell count sequence refers to a ranking sequence consisting of a count of target cells or a count of non-target cells in a historical fine sorting operation and the current fine sorting operation. By determining the flow rate of the intermediate cell suspension based on the cell count sequence, the purity of target cells obtained by the fine sorting and the efficiency of cell sorting can be ensured.

In some embodiments, after the at least one fine sorting operation has been completed, during a next fine sorting operation, the processor 110 may cause the intermediate cell suspension in the solution bag to flow through the sorting column at the sorting flow rate. The sorting flow rate is a corrected flow rate of the intermediate cell suspension based on the cell count sequence. For example, the sorting flow rate may be 4 mL/min, 5 mL/min, 6 mL/min, etc. More details regarding the solution bag can be found elsewhere in the present disclosure (e.g., the description in connection with FIG. 5). During the fine sorting operation, the flow rate of the intermediate cell suspension may need to be maintained as low as possible to ensure that the intermediate cell suspension is adequately sorted. However, a low flow rate of the intermediate cell suspension results in a low sorting efficiency, so the flow rate of the intermediate cell suspension may be corrected to maintain a more reasonable flow rate, which takes into account both an adequate sorting and the sorting efficiency.

In some embodiments, the processor 110 may determine the sorting flow rate based on the cell count sequence. The cell count sequence refers to a ranking sequence consisting of the count of target cells or the count of non-target cells in the historical fine sorting operation and the current fine sorting operation. For example, the cell count sequence may be a ranking sequence consisting of the count of cells in the non-target cell bag after the at least one fine sorting operation has been completed. The cell count sequence may reflect a screening situation of labeled cells after each fine sorting operation. In the following, the cell count sequence consisting of the count of non-target cells in the historical fine sorting operation and the current fine sorting operation is taken as an example for illustration. In some embodiments, the count of cells in the non-target cell bag after each fine sorting operation is determined by the processor 110. For example, the processor 110 may dilute a suspension in the non-target cell bag at a certain concentration; use a five-point sampling from the diluted solution (e.g., 2 mL) and calculate a total count of sampled cells; and calculate a final count of cells (i.e., the count of labeled cells) according to a proportional relationship between the diluted solution and the sampled cells. The cell count sequence may be obtained by ranking the count of cells after each fine sorting operation. It may be understood that the cell count sequence may be a ranking sequence in which the count of non-target cells gradually increases, but an amount of each increase gradually decreases. For example, the cell count sequence may be a ranking sequence consisting of a count of cells of 5.0e9, 5.2e9, 5.3e9, etc. Each increase in the cell count sequence is less than a preset increase threshold, indicating that the non-target cells have been gradually sorted out and the sorting flow rate may be appropriately increased to improve the sorting efficiency. Each increase in the cell count sequence is greater than the preset increase threshold, indicating that the elution in the current fine sorting operation is less effective, and the sorting flow rate may be reduced appropriately to improve the sorting effect. A change value of the sorting flow rate may be in a preset numerical relationship with the cell count sequence.

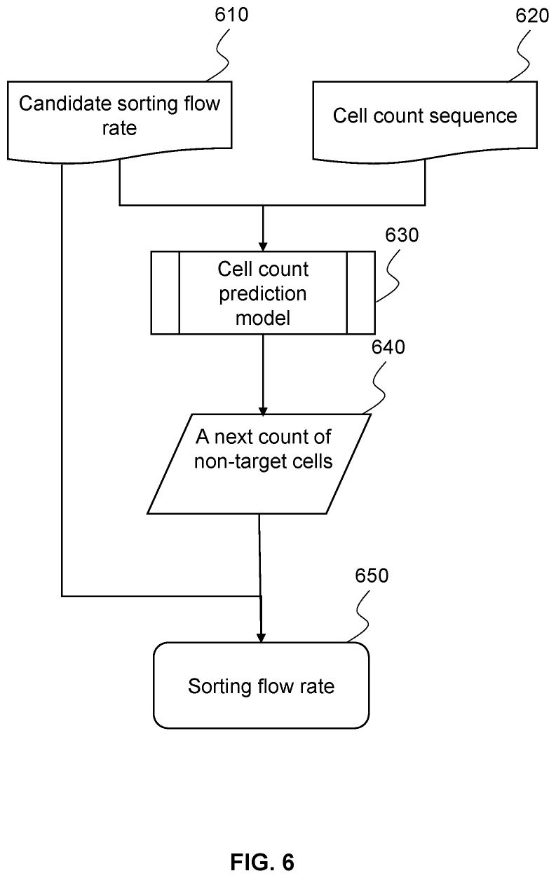

In some embodiments, the processor 110 may preset a plurality of candidate sorting flow rates; for each candidate sorting flow rate, predict a count of non-target cells in the non-target cell bag after the next fine sorting operation by using a cell count prediction model based on the cell count sequence and the candidate sorting flow rate; and determine the sorting flow rate based on the count of non-target cells in the non-target cell bag after the next fine sorting operation and the candidate sorting flow rate. More details regarding the sorting flow rate can be found elsewhere in the present disclosure (e.g., the description in connection with FIG. 6).

In some embodiments, in a process for performing the at least one fine sorting operation: after performing the current fine sorting operation, the processor 110 determines whether to perform the next fine sorting operation based on the cell count sequence. For example, when a count of cells of a most recent fine sorting operation in the cell count sequence is greater than a preset cell count threshold, it indicates that a current elution is not clean, and the processor 110 may determine that the next fine sorting operation needs to be performed. When the count of cells of the most recent fine sorting operation in the cell count sequence is less than the preset cell count threshold, it indicates that the current elution is clean, and the processor 110 may determine that the next fine sorting operation does not need to be performed.

In some embodiments, the processor 110 may predict a next count of non-target cells by using the cell count prediction model based on the cell count sequence, and determine whether to perform the next fine sorting operation based on a prediction result.

In some embodiments, the processor 110 may predict the next count of non-target cells by using the cell count prediction model based on the cell count sequence and the sorting flow rate. The next count of non-target cells refers to a count of non-target cells in the non-target cell bag after the next fine sorting operation. For example, an input of the cell count prediction model may include the cell count sequence and the sorting flow rate, and an output of the cell count prediction model may include the next count of non-target cells (i.e., the prediction result). In this embodiment, the sorting flow rate is introduced as the input, and factors related to the flow rate of the cell suspension may be introduced into the cell count prediction model to further improve prediction accuracy of the cell count prediction model.

In some embodiments, the processor 110 may determine whether to perform the next fine sorting operation based on the prediction result. For example, when an increase in the next count of non-target cells (i.e., the prediction result) is greater than the preset cell count threshold, the processor 110 may determine that the next fine sorting operation needs to be performed. When the increase in the next count of non-target cells (i.e., the prediction result) is less than the preset cell count threshold, the processor 110 may determine that the next fine sorting operation does not need to be performed.

The method for cell sorting provided by this embodiment achieves a rapid sorting of a suspension with a large volume. Through a plurality of washings and elution, a loss of target cells can be minimized while simultaneously improving a recovery rate of the target cells. In addition, by classifying a sorting process into the rough sorting operation and at least one fine sorting operation and controlling the count of iterations of the rough sorting operation and a count of fine sorting operations, the sorting efficiency can be improved maximized while ensuring sorting quality.

It should be noted that the above descriptions of cell sorting are merely provided for the purposes of illustration and does not limit the scope of application of the present disclosure. For those skilled in the art, various amendments and changes to process cell sorting may be made under the guidance of the present disclosure. However, these amendments and changes remain within the scope of the present disclosure.

FIG. 5 is a flowchart illustrating an exemplary process for cell sorting according to some embodiments of the present disclosure. As shown in FIG. 5, process 500 may include the following steps:

Step 510, pre-filling. In step 510, processor 110 may perform pipeline filling or perfusion to remove air from the pipeline after starting cell sorting device 140.

Step 520, a rough sorting operation. In step 520, the processor 110 may cause an initial cell suspension to flow through a sorting column in portions to perform an iteration of the rough sorting operation on each portion. Additionally, the processor 110 may wash one or more of the sorting column, a connecting pipeline, and a sample bag in each iteration of the rough sorting operation. In some embodiments, the processor 110 may perform the rough sorting operation, a column washing, and an elution sequentially (i.e., a first predetermined process) on each portion of the initial cell suspension until an end condition is met. More details about the end condition may be found in FIG. 4 and related descriptions thereof.

The processor 110 cause the initial cell suspension with the first volume in a sample bag to flow through a sorting column and enter into a solution bag, thereby completing the rough sorting operation.

The processor 110 may wash the sorting column to generate a first washing mixture, and cause the first washing mixture to flow into the solution bag. The column washing is a process of washing unabsorbed cells in the sorting column. During the column washing, the washing solution passes through the connecting pipeline, which causes the connecting pipeline also to be washed to prevent target cells from being retained in the connecting pipeline. Unabsorbed cells may include target cells and non-target cells. In some embodiments, the processor 110 may temporarily store the first washing mixture in the solution bag for subsequent fine sorting operations. The target cells in the sorting column may be collected to prevent a loss of target cells through the column washing, which improves a target cell recovery rate.

The processor 110 may perform the elution on the sorting column, and cause a first eluting mixture to flow into a non-target cell bag. The elution is a process of washing absorbed labeled cells on the sorting column. In some embodiments, the processor 110 may remove a magnetic field, release the sorting column and wash the sorting column through a buffer solution. The elution allows the sorting column to return to an initial state of no labeled cells, allowing it to adsorb a next count of new labeled cells, avoiding a missed sorting of labeled cells due to a limitation of the sorting column. The first eluting mixture may be temporarily stored in the non-target cell bag and is no longer used subsequently. The first eluting mixture after the elution is a mixture with the labeled cells, that is, a mixture with labeled non-target cells.

In some embodiments, in response to meeting the end condition, the method for cell sorting also includes washing a sample bag and performing the elution on the sorting column (i.e., a second predetermined process) before the fine sorting operation.

The processor 110 may wash the sample bag to generate a second washing mixture, and cause the second washing mixture to flow into the solution bag. The bag washing is a process of washing the sample bag. During the bag washing, a washing solution passes through the sorting column and the connecting pipeline, which causes the sorting column and the connecting pipeline also to be washed to prevent the target cells from being retained in the sorting column and the connecting pipeline. The sample bag may contain residual target cells and residual non-target cells. In some embodiments, the processor 110 may temporarily store the second washing mixture in the solution bag after the bag washing for the subsequent fine sorting operations. A loss of target cells from the sample bag may be reduced through the bag washing, which improves a cell recovery rate.

The processor 110 may perform the elution on the sorting column to generate the second eluting mixture, and the cause the second eluting mixture to flow into the non-target cell bag. The elution is a process of washing the absorbed labeled cells on the sorting column again. Since the bag washing may cause a few labeled cells to be adsorbed on the sorting column, the processor 110 may wash the sorting column again to prevent new labeled cells from remaining and to ensure that the sorting column is in the state of no labeled cells.

Step 530, fine sorting operations. In step 530, processor 110 may perform at least one fine sorting operation. In some embodiments, the fine sorting operation may be performed in a third predetermined process including: the fine sorting operation, a column washing, an elution, and a bag washing.

The processor 110 cause an intermediate cell suspension in the solution bag to flow through the sorting column and enter into a cell collection bag, thereby completing the fine sorting operation.

The processor 110 may wash the sorting column to generate a third washing mixture, and cause the third washing mixture to flow into the cell collection bag.

The processor 110 may perform the elution on the sorting column to generate a third eluting mixture, and cause the third eluting mixture to flow into a non-target cell bag.

The processor 110 may wash the solution bag to generate a fourth washing mixture, and cause the fourth washing mixture to flow into the sorting column and enter into the cell collection bag. In the fine sorting operation, performing the elution first and then the bag washing may fully release the sorting column, and the elution leaves the sorting column in the state of no labeled cells, causing new labeled cells to be absorbed better.

The processor 110 allows the intermediate cell suspension in the sample bag to flow through the sorting column and enter into the solution bag, thereby completing the fine sorting operation. In some embodiments, after the third predetermined process is executed, the fine sorting operation also includes a bag washing, a column washing, and an elution.

The processor 110 may wash the sample bag to generate a fifth washing mixture, and cause the fifth washing mixture to flow into the sorting column and enter into the cell collection bag.

The processor 110 may wash the sorting column to generate a sixth washing mixture, and cause the sixth washing mixture to enter into the cell collection bag.

The processor 110 may perform the elution on the sorting column to generate a fourth eluting mixture, and cause the fourth eluting mixture to enter into the non-target cell bag. The column washing, the elution, and the bag washing of the fine sorting operation are similar to the corresponding operations in the rough sorting operation and are not repeated here.

In some embodiments, the cell sorting is completed in response to the step 530 satisfying a first preset condition, otherwise, the step 530 is repeated. The first preset condition may be that the step 530 is performed to reach a preset count of fine sorting operations, or that the next fine sorting operation is not performed based on a cell count sequence. Determining whether to perform the next fine sorting operation based on the cell count sequence may be found in FIG. 4 and related descriptions.

TABLE 1

| | The example using the | |
|---|---|---|
| | method for cell sorting in | The control |
| Examples | the present disclosure | example |
| Loading cell count | 10e9 | 10e9 |
| A purity of target cells | 99.0% | 96.0% |

TABLE 2

| | The example using the | |
|---|---|---|
| | method for cell sorting in | The control |
| Examples | the present disclosure | example |
| Loading cell count | 10.5e9 | 10.5e9 |
| A purity of target cells | 99.6% | 97.0% |

Table 1 is an exemplary data table illustrating an example using the method for cell sorting of the present disclosure and a control example. Table 2 is an exemplary data table illustrating another example using the method for cell sorting of the present disclosure and the control example.

The cell types sorted in the embodiment of the present disclosure and the control example are CD3, TCRα/TCRβ. The method for cell sorting in the example of the present disclosure includes the pre-filling, rough sorting operation, and fine sorting operation. A count of iterations of the rough sorting operation is 1, i.e., the processor 110 causes the initial cell suspension to flow through the sorting column to perform the first predetermined process, i.e., the rough sorting operation, the column washing, the elution. After the first predetermined process and before the fine sorting operation, the processor 110 executes the second predetermined process, i.e., the bag washing and the elution. The fine sorting operation includes one fine sorting operation, i.e., the fine sorting operation, the column washing, the elution, the bag washing, the bag washing, the column washing, and the elution. A sorting flow rate in the rough sorting operation is 18 mL/min and a sorting flow rate in the fine sorting operation is 5 mL/min.

The method for cell sorting in the control example includes pre-filling, rough sorting operation, and fine sorting operation. The rough sorting operation here further includes the bag washing, the column washing, and the elution. The fine sorting operation here further includes the bag washing, the column washing, and the elution. The sorting flow rate of the rough sorting operation is 18 mL/min and the sorting flow rate of the fine sorting operation is 12 mL/min.

Table 1 illustrates a purity of the target cells of the example of the present disclosure and the control example in the case of a loading cell count of 10e9. By performing the method for cell sorting, the example of the present disclosure achieves a purity of 99.0% while the control example only achieves a purity of 96%. Table 2 shows the purity of the target cells in the example of the present disclosure and the control example in the case of the loading cell count of 10.5e9. By performing the method for cell sorting, the example of the present disclosure achieves a purity of 99.6%, while the control example only achieves a purity of 97%. From the above data, it is clear that a higher purity of the target cells may be obtained by performing the method for cell sorting of the present disclosure under different loading cell counts.

Compared with the control example, in the rough sorting operation of the example of the present disclosure, the elution is executed in the first predetermined process before the bag washing is executed in the second predetermined process, so that the sorting column is in the state of no labeled cells through the elution, which causes the new labeled cells to be absorbed better; in the rough sorting operation, the column washing and the elution (i.e., the second predetermined process) are added after the first predetermined process and before the fine sorting operation to reduce the loss of target cells, and the elution is also added to release the sorting column so that the labeled cells may be absorbed better; in the fine sorting operation, three fine sorting operations were performed, the added fine sorting operation is mainly loaded with the cell suspensions containing the target cells produced during the bag washing, which can improve the recovery rate; the lower sorting flow rate of the fine sorting operation allows for a more adequate fine sorting operation. Thus, by performing the method for cell sorting of the present disclosure, the higher purity of the target cells may be obtained.

By performing the method for cell sorting of the present disclosure, the higher purity of the target cells is obtained, and the method provided in the embodiment is reproducible without involving complex processes and devices.

It should be noted that the above description of cell sorting is for example and illustration purposes only and does not limit the scope of application of the present disclosure. For those skilled in the art, various corrections and changes to process cell sorting may be made under the guidance of the present disclosure. However, these corrections and changes are still within the scope of the present disclosure.

FIG. 6 is a flowchart illustrating an exemplary process of determining a sorting flow rate according to some embodiments of the present disclosure.

In some embodiments, a processor may preset a plurality of candidate sorting flow rates 610. For each of the plurality of candidate sorting flow rates 610, the processor may predict a next count of non-target cells 640 through a cell count prediction model 630 based on a cell count sequence 620 and the candidate sorting flow rate 610; and determine the sorting flow rate 650 based on the next count of non-target cells 640 and the candidate sorting flow rate 610. The next count of non-target cells is a count of non-target cells in a non-target cell bag after a next fine sorting operation.

The candidate sorting flow rate refers to an optional sorting flow rate. The candidate sorting flow rate may be a preset value, a default value, an experience value, etc.

The cell count prediction model 630 may be a machine learning model for predicting the next count of non-target cells. For example, the cell count prediction model may include a deep neural network (DNN) model, etc.

In some embodiments, an input of the cell count prediction model 630 may include the candidate sorting flow rate 610 and the cell count sequence 620; an output of the cell count prediction model may include the next count of non-target cells 640. More descriptions regarding the cell count sequence may be found in FIG. 4 and related descriptions thereof.

In some embodiments, the cell count prediction model may be obtained by training with a plurality of sets of training samples with labels. For example, the plurality of training samples with the labels may be input into an initial cell count prediction model, a loss function may be constructed from the labels and results of the initial cell count prediction model, and parameters of the initial cell count prediction model may be updated iteratively based on the loss function. When the loss function of the initial cell count prediction model satisfies an iterative condition, the model training is completed and a trained cell count prediction model is obtained. The iterative condition may include that the loss function converges, a count of iteration reaches a threshold, etc.

In some embodiments, a training sample may include a sample candidate sorting flow rate and a sample cell count sequence; and a label may include a sample next count of non-target cells. In some embodiments, the training sample may be obtained based on historical data (e.g., a historical candidate sorting flow rate and a historical cell count sequence); the label may be determined by experimentally measuring a cell suspension in the non-target cell bag after the next fine sorting operation in the case where the sample candidate sorting flow rate corresponds to the sample cell count sequence.

In some embodiments, for each candidate sorting flow rate, the processor may determine an evaluation value by a weighted summation of a reciprocal of the candidate sorting flow rate and an increasing amount of the next count of non-target cells, rank evaluation values of all candidate sorting flow rates from smallest to largest, and designate a candidate sorting flow rate with a smallest evaluation value as the sorting flow rate. The increasing amount of the next count of non-target cells is calculated by subtracting a count of non-target cells in the non-target cell bag after a current fine sorting operation from a count of non-target cells in the non-target cell bag after the next fine sorting operation. Weight(s) used in the weighted summation may be a default value, a preset value, etc. The evaluation value may be a parameter used to comprehensively reflect sorting efficiency and sorting effect of the target cells in the case of the candidate sorting flow rate. It should be understood that the larger the candidate sorting flow rate, the higher the sorting efficiency of the target cells, the smaller the reciprocal of a corresponding candidate sorting flow rate, and the smaller the evaluation value obtained by the weighted summation. The increasing amount of the next count of non-target cells is less, indicating that the count of non-target cells in the cell suspension containing the target cells after the current cell sorting is less, the cell sorting effect is better, and the evaluation value obtained by the weighted summation is smaller.

In some embodiments, the processor may also determine a sorting flow rate based on the increasing amount of the next count of non-target cells and the candidate sorting flow rate by other means. For example, the processor may designate a candidate sorting flow rate with the largest sorting flow rate among candidate sorting flow rates that meet a second preset condition as the sorting flow rate. The second preset condition may include that the increasing amount of the next count of non-target cells corresponding to the candidate sorting flow rate is less than a non-target cell count threshold. The non-target cell count threshold may be a default value, a preset value, etc.

In some embodiments, the candidate sorting flow rate and the cell count sequence are processed by the cell count prediction model to determine the next count of non-target cells, which takes into account effects of a plurality of factors, making the determination of the next count of non-target cells more efficient and accurate, and avoiding errors in manual determination. The sorting flow rate is then determined based on the next count of non-target cells and the candidate sorting flow rate while taking into account the sorting efficiency and the sorting effect of the target cells under each candidate sorting flow rate, making a final determined sorting flow rate more reasonable and accurate.

One or more embodiments of the present disclosure provide a non-transitory computer-readable storage medium, the storage medium stores computer instructions, when a computer reads the computer instructions in the storage medium, the computer performs the method for cell sorting as described in any one of the above embodiments.

The method and system for cell sorting have the following beneficial effects of embodiments of the present disclosure. (1) A certain count of non-target cells may be separated by a rough sorting operation, which increases the efficiency of a fine sorting operation and improves a purity of the target cells after the fine sorting operation. In addition, the rough sorting operation is performed in iterations, which achieves a sorting of cells from the suspension with a large volume. (2) The method for cell sorting allows for a rapid sorting of target cells from a suspension with a large volume; a loss of the target cells is minimized and a recovery rate of the target cells is increased by a plurality of washing operations and elution operations. In addition, by classifying sorting processes into the rough sorting process and the fine sorting process, and by controlling a count of iterations of the rough sorting operation and a count of the fine sorting operations, the sorting efficiency is improved as much as possible while ensuring the sorting quality. (3) A higher purity of the target cells may be obtained by performing the method for cell sorting in the present disclosure without involving complex processes and devices. (4) The next count of non-target cells can be determined by processing the candidate sorting flow rate and the cell count sequence using the cell count prediction model, which takes into account the effects of a plurality of factors, making a determination of the next count of non-target cells more efficient and accurate, and avoiding errors in manual determination. The sorting flow rate is then determined based on the next count of non-target cells and the candidate sorting flow rate while taking into account the sorting efficiency and the sorting effect of the target cells under each candidate sorting flow rate, making the final determined sorting flow rate more reasonable and accurate.

Having thus described the basic concepts, it may be rather apparent to those skilled in the art after reading this detailed disclosure that the foregoing detailed disclosure is intended to be presented by way of example only and is not limiting. Although not explicitly stated here, those skilled in the art may make various modifications, improvements, and amendments to the present disclosure. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or feature described in connection with the embodiment is included in at least one embodiment of the present disclosure. Therefore, it is emphasized and should be appreciated that two or more references to “an embodiment” or “one embodiment” or “an alternative embodiment” in various portions of the present disclosure are not necessarily all referring to the same embodiment. In addition, some features, structures, or characteristics of one or more embodiments in the present disclosure may be properly combined.

Furthermore, the recited order of processing elements or sequences, or the use of numbers, letters, or other designations therefore, is not intended to limit the claimed processes and methods to any order except as may be specified in the claims. Although the above disclosure discusses some embodiments of the invention currently considered useful by various examples, it should be understood that such details are for illustrative purposes only, and the additional claims are not limited to the disclosed embodiments. Instead, the claims are intended to cover all combinations of corrections and equivalents consistent with the substance and scope of the embodiments of the invention. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure does not mean that object of the present disclosure requires more features than the features mentioned in the claims. Rather, claimed subject matter may lie in less than all features of a single foregoing disclosed embodiment.

In some embodiments, the numbers expressing quantities or properties used to describe and claim certain embodiments of the present disclosure are to be understood as being modified in some instances by the term “about,” “approximate,” or “substantially.” For example, “about,” “approximate” or “substantially” may indicate+20% variation of the value it describes, unless otherwise stated. Accordingly, in some embodiments, the numerical parameters set forth in the written description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable.

Each of the patents, patent applications, publications of patent applications, and other material, such as articles, books, specifications, publications, documents, things, and/or the like, referenced herein is hereby incorporated herein by this reference in its entirety for all purposes. History application documents that are inconsistent or conflictive with the contents of the present disclosure are excluded, as well as documents (currently or subsequently appended to the present specification) limiting the broadest scope of the claims of the present disclosure. By way of example, should there be any inconsistency or conflict between the description, definition, and/or the use of a term associated with any of the incorporated material and that associated with the present document, the description, definition, and/or the use of the term in the present document shall prevail.

In closing, it is to be understood that the embodiments of the present disclosure disclosed herein are illustrative of the principles of the embodiments of the present disclosure. Other modifications that may be employed may be within the scope of the present disclosure Thus, by way of example, but not of limitation, alternative configurations of the embodiments of the present disclosure may be utilized in accordance with the teachings herein. Accordingly, embodiments of the present disclosure are not limited to that precisely as shown and described.

What is claimed is:

1. A method for cell sorting, comprising:
determining a count of iterations of a rough sorting operation based on a count of labeled cells in an initial cell suspension in a sample bag;
obtaining an intermediate cell suspension by performing the count of iterations of rough sorting operation on the initial cell suspension, which is divided into portions according to the count of iterations; and
performing at least one fine sorting operation on the intermediate cell suspension.

2. The method of claim 1, wherein performing the count of iterations of rough sorting operation on the initial cell suspension includes:
causing the initial cell suspension to flow through a sorting column in the portions according to the count of iterations to perform an iteration of the rough sorting operation on each portion; and
washing the sorting column in each iteration of the rough sorting operation.

3. The method of claim 2, wherein causing the initial cell suspension to flow through the sorting column in the portions according to the count of iterations to perform an iteration of the rough sorting operation on each portion includes:
executing a first predetermined process on each portion of the initial cell suspension successively until an end condition is met, wherein the first predetermined process includes:
causing each portion of the initial cell suspension in the sample bag to flow through the sorting column and enter into a solution bag;
washing the sorting column to generate a first mixture, and causing the first washing mixture to flow into the solution bag; and
performing elution on the sorting column to generate a first eluting mixture, and causing the first eluting mixture to flow into a non-target cell bag.

4. The method of claim 3, wherein in response to meeting the end condition, the method further includes executing a second predetermined process before performing the at least one fine sorting operation, wherein the second predetermined process includes:
washing the sample bag to generate a second washing mixture, and causing the second washing mixture to enter the solution bag; and
performing the elution on the sorting column to generate a second eluting mixture, and causing the second eluting mixture to flow into the non-target cell bag.

5. The method of claim 1, wherein performing the at least one fine sorting operation on the intermediate cell suspension includes:
causing the intermediate cell suspension to flow through the sorting column; and
washing the sorting column.

6. The method of claim 5, wherein the at least one fine sorting operation is performed in a third predetermined process, which includes:
causing the intermediate cell suspension in a solution bag to flow through the sorting column and enter into a cell collection bag;
washing the sorting column to generate a third washing mixture, and causing the third washing mixture to enter into the cell collection bag;
performing the elution on the sorting column to generate a third eluting mixture, and causing the third eluting mixture to flow into a non-target cell bag;
washing the solution bag to generate a fourth washing mixture, and causing the fourth washing mixture to flow into the sorting column and enter into the cell collection bag.

7. The method of claim 1, wherein determining the count of iterations of rough sorting operation based on the count of labeled cells in the initial cell suspension in the sample bag includes:
determining the count of labeled cells based on a sample concentration, a sample volume, and a percentage of the labeled cells input by a user; and
determining the count of iterations of rough sorting operation based on the count of labeled cells.

8. The method of claim 1, wherein performing the at least one fine sorting operation on the intermediate cell suspension includes:
after completing a current fine sorting operation, determining whether to perform a next fine sorting operation based on a cell count sequence, the cell count sequence being a ranking sequence consisting of a count of target cells or a count of non-target cells in a historical fine sorting operation and the current fine sorting operation.

9. A system for cell sorting, comprising:
at least one storage device including a set of instructions; and
at least one processor in communication with the at least one storage device, wherein when executing the set of instructions, the at least one processor is directed to cause the system to perform operations including:
determining a count of iterations of a rough sorting operation based on a count of labeled cells in an initial cell suspension in a sample bag;
obtaining an intermediate cell suspension by performing the count of iterations of rough sorting operation on the initial cell suspension, which is divided into portions according to the count of iterations; and
performing at least one fine sorting operation on the intermediate cell suspension.

10. The system of claim 9, wherein performing the count of iterations of rough sorting operations on the initial cell suspension includes:
causing the initial cell suspension to flow through a sorting column in the portions according to the count of iterations to perform an iteration of the rough sorting operation on each portion; and
washing the sorting column in each iteration of the rough sorting operation.

11. The system of claim 10, wherein causing the initial cell suspension to flow through the sorting column in the portions according to the count of iterations to perform an iteration of the rough sorting operation on each portion includes:
executing a first predetermined process on each portion of the initial cell suspension successively until an end condition is met, wherein the first predetermined process includes:
causing each portion of the initial cell suspension in the sample bag to flow through the sorting column and enter into a solution bag;
washing the sorting column to generate a first mixture, and causing the first washing mixture to flow into the solution bag; and
performing elution on the sorting column to generate a first eluting mixture, and causing the first eluting mixture to flow into a non-target cell bag.

12. The system of claim 11, wherein in response to meeting the end condition, the method further includes executing a second predetermined process before performing the at least one fine sorting operation, wherein the second predetermined process includes:
washing the sample bag to generate a second washing mixture, and causing the second washing mixture to enter the solution bag; and
performing the elution on the sorting column to generate a second eluting mixture, and causing the second eluting mixture to flow into the non-target cell bag.

13. The system of claim 9, wherein performing the at least one fine sorting operation on the intermediate cell suspension includes:
causing the intermediate cell suspension to flow through the sorting column; and
washing the sorting column.

14. The system of claim 13, wherein the at least one fine sorting operation is performed in a third predetermined process, which includes:
causing the intermediate cell suspension in a solution bag to flow through the sorting column and enter into a cell collection bag;
washing the sorting column to generate a third washing mixture, and causing the third washing mixture to enter into the cell collection bag;
performing the elution on the sorting column to generate a third eluting mixture, and causing the third eluting mixture to flow into a non-target cell bag;
washing the solution bag to generate a fourth washing mixture, and causing the fourth washing mixture to flow into the sorting column and enter into the cell collection bag.

15. The system of claim 9, wherein determining the count of iterations of rough sorting operation based on the count of labeled cells in the initial cell suspension in the sample bag includes:
determining the count of labeled cells based on a sample concentration, a sample volume, and a percentage of the labeled cells input by a user; and
determining the count of iterations of rough sorting operation based on the count of labeled cells.

16. The system of claim 9, wherein performing the at least one fine sorting operation on the intermediate cell suspension includes:
after completing a current fine sorting operation, determining whether to perform a next fine sorting operation based on a cell count sequence, the cell count sequence being a ranking sequence consisting of a count of target cells or a count of non-target cells in a historical fine sorting operation and the current fine sorting operation.

17. A non-transitory computer-readable storage medium storing computer instructions, wherein when reading the computer instructions in the storage medium, a computer performs a method for cell sorting, comprising:
determining a count of iterations of a rough sorting operation based on a count of labeled cells in an initial cell suspension in a sample bag;
obtaining an intermediate cell suspension by performing the count of iterations of rough sorting operation on the initial cell suspension, which is divided into portions according to the count of iterations; and
performing at least one fine sorting operation on the intermediate cell suspension.
